(19) United States
(12) Patent Application Publication
(10) Pub. No.: US 2024/0315251 A1
(43) Pub. Date: Sep. 26, 2024

(54) NOVEL COMPOSITIONS COMPRISING ANIONIC SURFACTANT CONTAINING SULFATE OR SULFONATE GROUP

(71) Applicant: ADAMA MAKHTESHIM LTD., Beer Sheva (IL)

(72) Inventors: Venkateswararao YADAGANI, Hyderabad (IN); Arunagirinathan Manickam ADHIMOOLAM, Chennai (IN)

(73) Assignee: ADAMA MAKHTESHIM LTD., Beer Sheva (IL)

(21) Appl. No.: 18/556,246

(22) PCT Filed: Apr. 19, 2022
(86) PCT No.: PCT/IL2022/050408

§ 371 Date: Oct. 19, 2023

(30) Foreign Application Priority Data
Apr. 20, 2021 (IN) 202111018285

(51) Int. Cl. A01N 57/28; A01N 25/30; A01N 59/02; A01P 7/04

(52) U.S. Cl. CPC A01N 57/28; A01N 25/30; A01N 59/02; A01P 7/04

(57) ABSTRACT

The invention relates to solid agricultural pesticide compositions of reduced odor, high efficacy and high dispersibility, containing at least one insecticide which is substantially insoluble in water, anionic surfactant containing sulfate or sulfonate functional group, an ammonium salt and a earner. The invention also relates to a solid agrochemical composition comprising acephate, ammonium salt and a carrier. In addition, the invention describes a method for reducing the odor of compositions containing acephate characterized by adding ammonium salt to solid compositions containing acephate and a carrier. The invention further provides the use of ammonium salts for reducing the odor of solid compositions containing acephate and a earner.

### TECHNICAL FIELD OF THE INVENTION

The present invention provides solid agricultural pesticide compositions of reduced odor, high efficacy and high dispersibility, containing at least one insecticide which is substantially insoluble in water, anionic surfactant containing sulfate or sulfonate functional group, an ammonium salt and a carrier.

### BACKGROUND OF THE INVENTION

Solid agrochemical compositions such as water dispersible granules provide a system for delivering solid active ingredients to a target organism. They allow for the production of highly concentrated formulations which are easily disintegrated on contact with water, reduces inhalation hazard due low dust parameters, do not show crystal growth or sedimentation and enables easier package disposal than for liquid formulations.

The quality of a pesticide formulation is greatly dependent on its physicochemical properties. These physicochemical properties are significantly altered by factors such as moisture content in the final composition inter alia on the method of its drying, temperature, purity of the active contents and the raw material etc.

Non-uniform dissolution (dispersion) of the pesticide composition leads to lack of homogeneity in the resulting mixture and prevents distribution of constant concentration of the desired active in the field. Less than optimal concentration of the active applied to the field lead to waste of the active, may cause toxicity problems and risk for increasing the resistance of pests to the active.

Solid compositions that are being used for combating insecticidal attacks on plants are widely available in the market; however, the users have regularly encountered various technical difficulties with commercially available formulations and there is always a need to develop more efficient and stable compositions therefore achieving high efficacy and user friendly products which overcomes one or more problem, faced in the art.

### SUMMARY

The present invention therefore provides a composition comprising a) at least one insecticide which is substantially insoluble in water; b) ammonium salt; c) at least one anionic surfactant containing sulfate or sulfonate functional group and d) a carrier.

The present invention is also directed to a solid agrochemical composition comprising acephate, ammonium salt and a carrier.

In addition, the present invention is directed to a method for reducing the odor of compositions containing acephate characterized by adding ammonium salt to solid compositions containing acephate and a carrier.

The present invention further provides the use of ammonium salts for reducing the odor of solid compositions containing acephate and a carrier.

### DETAILED DESCRIPTION OF THE PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, UK, 2003), as well as “The e-Pesticide Manual, Version 3” (British Crop Protection Council, Hampshire, UK, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

As used herein the term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

As used herein the term aryloxy relates to aryl radical united with oxygen.

As used herein the term substantially insoluble in water refers to insecticide which have solubility in water less than 200 mg/l.

As used herein the term lignosulphonate relates to a water-soluble anionic poly-electrolyte polymer derived as by-product from processing of wood pulp and modified further if required. These are highly branched macromolecules containing interconnected phenylpropane units and aromatic rings with heterogenic functionalities including sulphonic, carboxylic and hydroxyl groups.

The present invention provides solid agrochemical composition comprising a) at least one insecticide which is substantially insoluble in water; b) ammonium salt; c) at least one anionic surfactant containing sulfate or sulfonate functional group and d) a carrier.

In some embodiments, the at least one anionic surfactant containing sulfate or sulfonate functional group is selected from a) optionally alkylated naphthalene sulfonate condensate; b) lignosulphonates and/or compounds having the formula (I):

MO—SO₂-(CqH2q)p-[D]z-(CmH2mO)x-(CnH2nO)y-R

wherein R is linear or branched, saturated or unsaturated alkyl radical having from 7 to 20 carbon atoms; or R is a saturated or unsaturated carbonyl radical having from 5 to 20 carbon atoms; or R is aryl, alkyl aryl or aryloxy radical which is optionally mono-to trisubstituted by alkyl or styryl group; or any combination thereof, D represents oxygen or methylated Nitrogen, M represents an ammonium or alkali metal cation, z is an integer from 0 to 1, p is an integer from 0 to 1, m is an integer equal to 2, n is an integer equal to 3, q is an integer of from 2 to 3, x is an integer of from 0 to 50 and y is an integer of from 0 to 50.

In some embodiments, R is linear or branched, saturated or unsaturated alkyl radical having from 7 to 20 carbon atoms.

In some embodiments, R is linear or branched, saturated or unsaturated alkyl radical having from 7 to 20 carbon atoms, M represents an ammonium or alkali metal cation, p, x, y equal to 0; D represent an oxygen and z equals to 1.

In some embodiments, R is linear or branched, saturated or unsaturated alkyl radical having from 7 to 20 carbon atoms, M represents an ammonium or alkali metal cation, and p, x, y, z equal to 0.

In some embodiments, R is linear or branched, saturated or unsaturated alkyl radical having from 7 to 20 carbon atoms, M represents an ammonium or alkali metal cation, p, y equal to 0; D represent an oxygen; x is an integer of from 0 to 50; m equals to 2 and z equals to 1.

In some embodiments, R is a saturated or unsaturated carbonyl radical having from 5 to 20 carbon atoms.

In some embodiments, R is a saturated or unsaturated carbonyl radical having from 5 to 20 carbon atoms, M represents an ammonium or alkali metal cation, p equals to 1; D represent an oxygen and x, y equal to 0.

In some embodiments, R is a saturated or unsaturated carbonyl radical having from 5 to 20 carbon atoms, M represents an ammonium or alkali metal cation, p equals to 1; D represent a methylated Nitrogen and x, y equal to 0.

In some embodiments, R is aryl, alkyl aryl or aryloxy radical which is optionally mono-to trisubstituted by alkyl or styryl group.

In some embodiments, R is aryl, alkyl aryl or aryloxy radical which is optionally mono-to trisubstituted by alkyl or styryl group, M represents an ammonium or alkali metal cation, x is an integer of from 0 to 50; m equals to 2 and z equals to 1; p, y equal to 0 and D represent an oxygen.

Non limiting examples of anionic surfactant containing sulfate or sulfonate functional group having the formula (I) include salts of alkyl sulfate such as sodium dodecyl sulphate, sodium decyl sulphate; salts of alkyl ether sulfate such as sodium lauryl ether sulfate; salts of alkyl sulfonate such as sodium C14-16 olefin sulfonate; salts of alkyl aryl sulfonate such as sodium dodecyl benzene sulfonate; salts of alkyl isethionate such as sodium lauroyl isethionate and sodium cocoyl isethionate; salts of alkyl taurate such as sodium N-lauroyl-N-methyltaurate and sodium N-methyl-N-oleoyltaurate; salts of alkyl aryl alkoxylate sulfate such as mono, di and tri-styryl phenol propylene oxide (PO) and/or ethylene oxide (EO) sulfate; salts of alkyl aryl sulfonate such as alkyl naphthalene sulfonate sodium salt.

Alkyl naphthalene sulfonate are molecules with more than one alkyl group and sulfonate group per naphthalene molecule. Particularly preferred alkyl naphthalene sulfonates with alkyl groups containing from 1 to 4 carbon atoms. Non limiting example of anionic surfactant containing sulfate or sulfonate functional group selected from optionally alkylated naphthalene sulfonate is sodium isopropyl naphthalene sulfonate.

Non limiting examples of anionic surfactant containing sulfate or sulfonate functional group selected from optionally alkylated naphthalene sulfonate condensate include naphthalenesulfonic acid, polymer with formaldehyde, sodium salt and naphthalenesulfonic acid, polymer with formaldehyde, ammonium salt.

The anionic surfactants containing sulfate or sulfonate functional group described herein functions as wetting agents and/or dispersants for the water-insoluble pesticide, allowing the particles of the water-insoluble pesticide to be suspended in water. It was surprisingly discovered that the anionic surfactant containing sulfate or sulfonate functional group in the presence of ammonium salt can be used to form a stable composition showing excellent dispersibility and homogenous distribution of suspended particles in water.

In some embodiments, the amount of the at least one anionic surfactant containing sulfate or sulfonate functional group is equal to or above about 2% based on the total weight of the composition. In a preferred embodiment, the amount of the at least one anionic surfactant containing sulfate or sulfonate functional group is equal to or above about 2.2% based on the total weight of the composition. In a more preferred embodiment, the amount of the at least one anionic surfactant containing sulfate or sulfonate functional group is equal to or above about 3% based on the total weight of the composition. In even more preferred embodiment, the amount of the at least one anionic surfactant containing sulfate or sulfonate functional group is equal to or above about 4% based on the total weight of the composition. In especially preferred embodiment, the amount of the at least one anionic surfactant containing sulfate or sulfonate functional group is equal to or above about 4.5% based on the total weight of the composition.

In some embodiments, the amount of the at least one anionic surfactant containing sulfate or sulfonate functional group is of about 2% to about 45%, based on the total weight of the composition.

In an embodiment, the amount of the at least one anionic surfactant containing sulfate or sulfonate functional group is of about 2.2% to about 45%, based on the total weight of the composition.

In an embodiment, the amount of the at least one anionic surfactant containing sulfate or sulfonate functional group is of about 3% to about 45%, based on the total weight of the composition.

In an embodiment, the amount of the at least one anionic surfactant containing sulfate or sulfonate functional group is of about 4% to about 45%, based on the total weight of the composition.

In an embodiment, the amount of the at least one anionic surfactant containing sulfate or sulfonate functional group is of about 4.5% to about 45%, based on the total weight of the composition.

In an embodiment, the amount of the at least one anionic surfactant containing sulfate or sulfonate functional group is of about 2% to about 40%, based on the total weight of the composition.

In an embodiment, the amount of the at least one anionic surfactant containing sulfate or sulfonate functional group is of about 2.2% to about 40%, based on the total weight of the composition.

In an embodiment, the amount of the at least one anionic surfactant containing sulfate or sulfonate functional group is of about 3% to about 40%, based on the total weight of the composition.

In an embodiment, the amount of the at least one anionic surfactant containing sulfate or sulfonate functional group is of about 4% to about 40%, based on the total weight of the composition.

In an embodiment, the amount of the at least one anionic surfactant containing sulfate or sulfonate functional group is of about 4.5% to about 40%, based on the total weight of the composition.

In an embodiment, the amount of the at least one anionic surfactant containing sulfate or sulfonate functional group is of about 2% to about 35%, based on the total weight of the composition.

In an embodiment, the amount of the at least one anionic surfactant containing sulfate or sulfonate functional group is of about 2.2% to about 35%, based on the total weight of the composition.

In an embodiment, the amount of the at least one anionic surfactant containing sulfate or sulfonate functional group is of about 3% to about 35%, based on the total weight of the composition.

In an embodiment, the amount of the at least one anionic surfactant containing sulfate or sulfonate functional group is of about 4% to about 35%, based on the total weight of the composition.

In an embodiment, the amount of the at least one anionic surfactant containing sulfate or sulfonate functional group is of about 4.5% to about 35%, based on the total weight of the composition.

In an embodiment, the amount of the at least one anionic surfactant containing sulfate or sulfonate functional group is of about 2% to about 30%, based on the total weight of the composition.

In an embodiment, the amount of the at least one anionic surfactant containing sulfate or sulfonate functional group is of about 2.2% to about 30%, based on the total weight of the composition.

In an embodiment, the amount of the at least one anionic surfactant containing sulfate or sulfonate functional group is of about 3% to about 30%, based on the total weight of the composition.

In an embodiment, the amount of the at least one anionic surfactant containing sulfate or sulfonate functional group is of about 4% to about 30%, based on the total weight of the composition.

In an embodiment, the amount of the at least one anionic surfactant containing sulfate or sulfonate functional group is of about 4.5% to about 30%, based on the total weight of the composition.

In an embodiment, the amount of the at least one anionic surfactant containing sulfate or sulfonate functional group is of about 2% to about 25%, based on the total weight of the composition.

In an embodiment, the amount of the at least one anionic surfactant containing sulfate or sulfonate functional group is of about 2.2% to about 25%, based on the total weight of the composition.

In an embodiment, the amount of the at least one anionic surfactant containing sulfate or sulfonate functional group is of about 3% to about 25%, based on the total weight of the composition.

In an embodiment, the amount of the at least one anionic surfactant containing sulfate or sulfonate functional group is of about 4% to about 25%, based on the total weight of the composition.

In an embodiment, the amount of the at least one anionic surfactant containing sulfate or sulfonate functional group is of about 4.5% to about 25%, based on the total weight of the composition.

In an embodiment, the amount of the at least one anionic surfactant containing sulfate or sulfonate functional group is of about 2% to about 20%, based on the total weight of the composition.

In an embodiment, the amount of the at least one anionic surfactant containing sulfate or sulfonate functional group is of about 2.2% to about 20%, based on the total weight of the composition.

In an embodiment, the amount of the at least one anionic surfactant containing sulfate or sulfonate functional group is of about 3% to about 20%, based on the total weight of the composition.

In an embodiment, the amount of the at least one anionic surfactant containing sulfate or sulfonate functional group is of about 4% to about 20%, based on the total weight of the composition.

In an embodiment, the amount of the at least one anionic surfactant containing sulfate or sulfonate functional group is of about 4.5% to about 20%, based on the total weight of the composition.

In an embodiment, the amount of the at least one anionic surfactant containing sulfate or sulfonate functional group is of about 2% to about 15%, based on the total weight of the composition.

In an embodiment, the amount of the at least one anionic surfactant containing sulfate or sulfonate functional group is of about 2.2% to about 15%, based on the total weight of the composition.

In an embodiment, the amount of the at least one anionic surfactant containing sulfate or sulfonate functional group is of about 3% to about 15%, based on the total weight of the composition.

In an embodiment, the amount of the at least one anionic surfactant containing sulfate or sulfonate functional group is of about 4% to about 15%, based on the total weight of the composition.

In an embodiment, the amount of the at least one anionic surfactant containing sulfate or sulfonate functional group is of about 4.5% to about 15%, based on the total weight of the composition.

In an embodiment, the amount of the at least one anionic surfactant containing sulfate or sulfonate functional group is of about 2% to about 10%, based on the total weight of the composition.

In an embodiment, the amount of the at least one anionic surfactant containing sulfate or sulfonate functional group is of about 2.2% to about 10%, based on the total weight of the composition.

In an embodiment, the amount of the at least one anionic surfactant containing sulfate or sulfonate functional group is of about 3% to about 10%, based on the total weight of the composition.

In an embodiment, the amount of the at least one anionic surfactant containing sulfate or sulfonate functional group is of about 4% to about 10%, based on the total weight of the composition.

In an embodiment, the amount of the at least one anionic surfactant containing sulfate or sulfonate functional group is of about 4.5% to about 10%, based on the total weight of the composition.

In some embodiments, the amount of the anionic surfactant containing sulfate or sulfonate functional group based on the total weight of the composition changes depending on its type. In some embodiments the concentration of the anionic surfactant containing sulfate or sulfonate functional group is equal or above 0.05 times its critical micelle concentration.

In some embodiments, the ammonium salt is selected from ammonium sulfate, ammonium acetate, ammonium carbonate, ammonium chloride and any combination thereof. In a preferred embodiment, the ammonium salt is ammonium sulfate.

In some embodiments, the ratio between the anionic surfactant containing sulfate or sulfonate functional group and the ammonium salt is of about 1:0.5 to of about 1:5. In a preferred embodiment, the ratio between the anionic surfactant containing sulfate or sulfonate functional group and the ammonium salt is of about 1:1 to of about 1:3. In a more preferred embodiment, the ratio between the anionic surfactant containing sulfate or sulfonate functional group and the ammonium salt is of about 1:1.2. In even more preferred embodiment, the ratio between the anionic surfactant containing sulfate or sulfonate functional group and the ammonium salt is of about 1:1.

In some embodiments, the carrier is selected from silica, layered silicate, phyllosilicate, china clay, bentonite, attapulgite, kaolin, diatomaceous earth, montmorillonite and any combination thereof.

In some embodiments, the amount of the carrier is of about 0.05% to about 1%, based on the total weight of the composition.

In more specific embodiment, the amount of carrier is of about 0.05%, 0.1%, 0.15%, 0.2%, 0.25%, 0.3%, 0.35%, 0.4%, 0.45%, 0.5%, 0.55%, 0.6%, 0.65%, 0.7%, 0.75%,0.8%, 0.85%, 0.9%, 0.95%, 1% by weight, based on the total weight of the composition.

In more specific embodiment, the amount of silica is of about 0.05%, 0.1%, 0.15%, 0.2%, 0.25%, 0.3%, 0.35%, 0.4%, 0.45%, 0.5%, 0.55%, 0.6%,0.65%, 0.7%,0.75%,0.8%, 0.85%, 0.9%, 0.95%, 1% by weight, based on the total weight of the composition.

In some embodiments, the at least one insecticide which is substantially insoluble in water is selected from the group of fipronil, pyrethroide, chlorantraniliprole, chlorfenapyr, chlorpyrifos, cyantraniliprole, fenoxycarb, flufenoxuron, hydramethylnon, imidacloprid, indoxacarb, metaflumizone, allethrin, alpha-cypermethrin, beta-cyfluthrin, bifenthrin, bioallethrin, cyfluthrin, cyhalothrin, cypermethrin, deltamethrin, etofenprox, fenoxycarb, flufenoxuron, permethrin, pyriproxifen, tebufenozide, tralomethrin and metaflumizone and any combination thereof. In a preferred embodiment, the at least one insecticide which is substantially insoluble in water is bifenthrin.

In some embodiments, the amount of the at least one insecticide which is substantially insoluble in water is of about 0.1% to about 90% by weight, based on the total weight of the composition. In a preferred embodiment, the amount of the at least one insecticide which is substantially insoluble in water is of about 0.5% to about 50% by weight, based on the total weight of the composition. In a more preferred embodiment, the amount of the at least one insecticide which is substantially insoluble in water is of about 1% to about 10% by weight, based on the total weight of the composition. In a specially preferred embodiment, the amount of the at least one insecticide which is substantially insoluble in water is of about 3.5% by weight by weight, based on the total weight of the composition.

In some embodiments, the amount of bifenthrin in the composition is of about 0.1% to about 90% by weight by weight, based on the total weight of the composition. In a preferred embodiment, the amount of bifenthrin in the composition is of about 0.5% to about 50% by weight by weight, based on the total weight of the composition. In a more preferred embodiment, the amount of bifenthrin in the composition is of about 1% to about 10% by weight, based on the total weight of the composition. In a specially preferred embodiment, the amount of bifenthrin is of about 3.5% by weight by weight, based on the total weight of the composition.

In some embodiments, the solid agrochemical composition further comprising phosphoramidothioate insecticide. In a preferred embodiment, the phosphoramidothioate insecticide is selected from acephate, chloramine phosphorus, isofenphos-methyl, methamidophos and any combination thereof. In a more preferred embodiment, the phosphoramidothioate insecticide is acephate.

In some embodiments, the amount of the phosphoramidothioate insecticide is of about 10% to about 90% by weight, based on the total weight of the composition. In a preferred embodiment, the amount of the phosphoramidothioate insecticide is of about 50% to about 90% by weight, based on the total weight of the composition. In a more preferred embodiment, the amount of the phosphoramidothioate insecticide is of about 80% to about 90% by weight, based on the total weight of the composition. In especially preferred embodiment, the amount of the phosphoramidothioate insecticide is of about 85% by weight, based on the total weight of the composition.

In an embodiment, the amount of acephate is of about 10% to about 90% by weight, based on the total weight of the composition. In a preferred embodiment, the amount of acephate is of about 50% to about 90% by weight, based on the total weight of the composition. In a more preferred embodiment, the amount of acephate is of about 80% to about 90% by weight, based on the total weight of the composition. In especially preferred embodiment, the amount of acephate is of about 85% by weight, based on the total weight of the composition.

In an embodiment, the solid agrochemical composition comprising a) bifenthrin, b) ammonium salt: c) at least one anionic surfactant containing sulfate or sulfonate functional group and d) a carrier.

In an embodiment, the solid agrochemical composition comprising a) bifenthrin, b) ammonium salt; c) at least one anionic surfactant containing sulfate or sulfonate functional group and d) a carrier: wherein the ratio between the at least one anionic surfactant containing sulfate or sulfonate functional group and the ammonium salt is of about 1:0.5 to of about 1:5.

In an embodiment, the solid agrochemical composition comprising a) bifenthrin, b) ammonium salt: c) at least one anionic surfactant containing sulfate or sulfonate functional group and d) a carrier: wherein the ratio between the at least one anionic surfactant containing sulfate or sulfonate functional group and the ammonium salt is of about 1:1 to of about 1:3.

In an embodiment, the solid agrochemical composition comprising a) bifenthrin, b) ammonium salt: c) at least one anionic surfactant containing sulfate or sulfonate functional group and d) a carrier: wherein the ratio between the at least one anionic surfactant containing sulfate or sulfonate functional group and the ammonium salt is of about 1:1.2.

In an embodiment, the solid agrochemical composition comprising a) bifenthrin, b) ammonium sulfate: c) at least one anionic surfactant containing sulfate or sulfonate functional group and d) a carrier.

In an embodiment, the solid agrochemical composition comprising a) bifenthrin, b) ammonium sulfate: c) at least one anionic surfactant containing sulfate or sulfonate functional group and d) a carrier: wherein the ratio between the at least one anionic surfactant containing sulfate or sulfonate functional group and the ammonium salt is of about 1:0.5 to of about 1:5.

In an embodiment, the solid agrochemical composition comprising a) bifenthrin, b) ammonium sulfate: c) at least one anionic surfactant containing sulfate or sulfonate functional group and d) a carrier: wherein the ratio between the at least one anionic surfactant containing sulfate or sulfonate functional group and the ammonium salt is of about 1:1 to of about 1:3.

In an embodiment, the solid agrochemical composition comprising a) bifenthrin, b) ammonium sulfate: c) at least one anionic surfactant containing sulfate or sulfonate functional group and d) a carrier: wherein the ratio between the at least one anionic surfactant containing sulfate or sulfonate functional group and the ammonium salt is of about 1:1.2.

In an embodiment, the solid agrochemical composition comprising a) bifenthrin, b) ammonium sulfate: c) at least one anionic surfactant containing sulfate or sulfonate functional group in an amount equal to or above 2% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 2% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount equal to or above 2.2% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 2.2% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount equal to or above 3% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 3% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount equal to or above 3.5% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 3.5% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount equal to or above 4% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 4% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount equal to or above 4.5% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount equal to or above 4.5% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2% to about 45% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2.2% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 45% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3% to about 45% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3.5% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 45% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 45% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4.5% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4.5% to about 45% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2% to about 40% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2.2% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 40% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3% to about 40% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3.5% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 40% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 40% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4.5% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4.5% to about 40% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 2% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2% to about 35% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 2.2% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 35% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 3% to about 35% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3.5% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 3.5% to about 35% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 35% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4.5% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 4.5% to about 35% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2% to about 30% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2.2% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 30% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3% to about 30% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3.5% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 30% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 30% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4.5% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4.5% to about 30% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 2% to about 25% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2.2% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 25% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3% to about 25% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3.5% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 3.5% to about 25% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 25% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4.5% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4.5% to about 25% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2% to about 20% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2.2% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 20% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 3% to about 20% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3.5% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 20% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 20% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4.5% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 4.5% to about 20% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 2% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 2% to about 15% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 2.2% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 2.2% to about 15% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3% to about 15% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3.5% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 15% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4% to about 15% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 4.5% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 4.5% to about 15% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 2% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 2% to about 10% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 2.2% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 2.2% to about 10% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 3% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 3% to about 10% by weight, based on the total weight of the composition and d) a carrier.

In an embodiment, the solid agrochemical composition comprising a) bifenthrin, b) ammonium sulfate; c) at least one anionic surfactant containing sulfate or sulfonate functional group in an amount of about 3.5% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) at least one anionic surfactant containing sulfate or sulfonate functional group in an amount of about 3.5% to about 10% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 4% to about 10% by weight, based on the total weight of the composition and d) a carrier.

In an embodiment, the solid agrochemical composition comprising a) bifenthrin, b) ammonium sulfate: c) at least one anionic surfactant containing sulfate or sulfonate functional group in an amount of about 4.5% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) at least one anionic surfactant containing sulfate or sulfonate functional group in an amount of about 4.5% to about 10% by weight, based on the total weight of the composition and d) a carrier.

In an embodiment, the solid agrochemical composition comprising a) bifenthrin, b) ammonium sulfate: c) tri-styryl phenol propylene oxide (PO) and/or ethylene oxide (EO) sulfate and/or sodium dodecyl sulphate in an amount equal to or above 2% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) tri-styryl phenol propylene oxide (PO) and/or ethylene oxide (EO) sulfate and/or sodium dodecyl sulphate in an amount equal to or above 2% by weight, based on the total weight of the composition and d) a carrier.

In an embodiment, the solid agrochemical composition comprising a) bifenthrin, b) ammonium sulfate: c) tri-styryl phenol propylene oxide (PO) and/or ethylene oxide (EO) sulfate and/or sodium dodecyl sulphate in an amount equal to or above 2.2% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) tri-styryl phenol propylene oxide (PO) and/or ethylene oxide (EO) sulfate and/or sodium dodecyl sulphate in an amount equal to or above 2.2% by weight, based on the total weight of the composition and d) a carrier.

In an embodiment, the solid agrochemical composition comprising a) bifenthrin, b) ammonium sulfate: c) in an amount equal to or above 3% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate: c) tri- styryl phenol propylene oxide (PO) and/or ethylene oxide (EO) sulfate and/or sodium dodecyl sulphate in an amount equal to or above 3% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount equal to or above 3.5% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount equal to or above 3.5% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount equal to or above 4% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount equal to or above 4% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount equal to or above 4.5% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount equal to or above 4.5% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 45% by weight, based on the total weight of the composition and d) a carrier.

In an embodiment, the solid agrochemical composition comprising a) bifenthrin, b) ammonium sulfate; c) in an amount of about 2.2% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 45% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 45% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 45% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 45% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 45% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 45% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 40% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 40% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 35% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 35% by weight, based on the total weight of the composition and d) a carrier.

In an embodiment, the solid agrochemical composition comprising a) bifenthrin, b) ammonium sulfate; c) in an amount of about 3% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 35% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 35% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 35% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 35% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 35% by weight, based on the total weight of the composition and d) a carrier.

In an embodiment, the solid agrochemical composition comprising a) bifenthrin, b) ammonium sulfate; c) in an amount of about 2% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 30% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 30% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 25% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 25% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 20% by weight, based on the total weight of the composition and d) a carrier.

In an embodiment, the solid agrochemical composition comprising a) bifenthrin, b) ammonium sulfate; c) in an amount of about 2.2% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 20% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 20% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 20% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 20% by weight, based on the total weight of the composition and d) a carrier.

In an embodiment, the solid agrochemical composition comprising a) bifenthrin, b) ammonium sulfate; c) in an amount of about 4.5% to about 20% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 20% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 15% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 15% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 2.2% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 2.2% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 3.5% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 3.5% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and/or sodium dodecyl sulphate in an amount of about 4.5% to about 10% by weight, based on the total weight of the composition and d) a carrier.

In an embodiment, the solid agrochemical composition comprising a) bifenthrin in an amount of about 1% to about 10% by weight, based on the total weight of the composition, b) ammonium sulfate; c) tri-styryl phenol propylene oxide (PO) and/or ethylene oxide (EO) sulfate and/or sodium dodecyl sulphate in an amount of about 4.5% to about 10% by weight, based on the total weight of the composition and d) a carrier.

In an embodiment, the solid agrochemical composition comprising a) bifenthrin, b) ammonium sulfate; c) tri-styryl phenol propylene oxide (PO) and/or ethylene oxide (EO) sulfate and d) a carrier.

In an embodiment, the solid agrochemical composition comprising a) bifenthrin, b) ammonium sulfate: c) sodium dodecyl sulphate and d) a carrier.

The present invention also provides a method for controlling animal pests comprising applying an effective amount of the solid agrochemical composition to a locus where the animal pest is to be controlled and/or prevented so as to thereby control and/or prevent the animal pest.

In some embodiments, the locus where the animal pest is to be controlled and/or prevented is a crop field.

The present invention also provides a method of controlling animal pests in a field of crop comprising applying an effective amount of the solid agrochemical composition disclosed herein to a field of crop so as to thereby control and/or prevent the animal pest.

In an embodiment, the crop field on which the solid agrochemical compositions of the present invention may be used may be selected from but not limited to cereals, such as wheat, oats, barley, spelt, triticale, rye, maize, millet, rice, crops such as sugarcane, soybean, sunflower, rape, canola, tobacco, sugar beet, fodder beet; tuber crops such as potatoes, sweet potatoes etc., crops such as asparagus, hops etc.,; fruit plants such as apples, pears, stone-fruits such as for example peaches, nectarines, cherries, plums, apricots, citrus fruits such as oranges, grapefruit, limes, lemons, kumquats, mandarins, satsumas; nuts such as pistachios, almonds, walnuts, pecan nuts, tropical fruits such as mango, papaya, pineapple, dates, bananas etc., grapes, vegetables such as endives, lambs, lettuce, fennel, globe and loose-leaf salad, chard, spinach, chicory, cauliflower, broccoli, Chinese cabbage, kale (winter kale or curly kale), kohlrabi, Brussel sprouts, red cabbage, white cabbage and savoy, fruiting vegetables such as aubergines, cucumbers, paprika, marrow, tomatoes, courgettes, sweetcorn, root vegetables such as celeriac, turnip, carrots, swedes, radishes, horse radish, beetroot, salsify, celery, pulses such as peas, beans etc., bulb vegetables such as leeks, onions etc., oil crops such as mustard, poppy, olives, sunflowers, coconut, castor oil plants, cocoa beans, groundnuts; fibre crops such as cotton, jute, flex, hemp, crops such as tea, coffee, rubber, ornamentals including shrubs and flowering plants, vines, rangeland and pastures. In a preferred embodiment the crop filed is selected from maize, rice, soybean, sweetcorn, groundnuts and cotton.

In an embodiment, the solid agrochemical compositions of the present invention give a quick knockdown kill of the animal pests. It is especially a potent lethal weapon to kill hard-to-kill animal pest, especially Lepidoptera, Coleoptra, Diptera, Hemiptera, preferably, effective against crop insects like aphids, white fly, thrips, fleahoppers, stink bugs and plant bugs.

In an embodiment, the solid agrochemical composition is applied in an amount from about 0.1 L/ha to of about 1 L/ha. In a more preferred embodiment, the solid agrochemical composition is applied in an amount of about 0.8 L/ha.

In some embodiments, the solid agrochemical composition is applied in an amount from about 10 g/ha of the at least one insecticide which is substantially insoluble in water to about 50 g/ha of the at least one insecticide which is substantially insoluble in water. In a more preferred embodiment, the solid agrochemical composition is applied in an amount of about 35 g/ha of the at least one insecticide which is substantially insoluble in water.

In some embodiments, the solid agrochemical composition is applied in an amount from about 100 g/ha of the phosphoramidothioate insecticide to about 1000 g/ha of the phosphoramidothioate insecticide. In a more preferred embodiment, the solid agrochemical composition is applied in an amount from about 400 g/ha of the phosphoramidothioate insecticide to about 900 g/ha of the phosphoramidothioate insecticide. In especially preferred embodiment, the solid agrochemical composition is applied in an amount of about 850 g/ha of the phosphoramidothioate insecticide.

The present invention also provides use of the solid agrochemical compositions disclosed herein for controlling animal pests. It is especially a potent lethal weapon to kill hard-to-kill animal pest, especially Lepidoptera, Coleoptra, Diptera, Hemiptera, preferably, effective against crop insects like aphids, white fly, thrips, fleahoppers, stink bugs and plant bugs.

The present invention also provides solid agrochemical composition comprising acephate, ammonium salt and a carrier.

In some embodiments, the ammonium salt is selected from ammonium sulfate, ammonium acetate, ammonium carbonate, ammonium chloride and any combination thereof. In a preferred embodiment, the ammonium salt is ammonium sulfate.

In some embodiments, the carrier is selected from silica, layered silicate, phyllosilicate, china clay, bentonite, attapulgite, kaolin, diatomaceous earth, montmorillonite and any combination thereof.

In some embodiments, the amount of acephate is of about 10% to about 90% by weight, based on the total weight of the composition. In a preferred embodiment, the amount of acephate is of about 50% to about 90% by weight, based on the total weight of the composition. In a more preferred embodiment, the amount of acephate is of about 80% to about 90% by weight, based on the total weight of the composition.

In some embodiments, the amount of ammonium salt is equal to or above about 0.5% by weight, based on the total weight of the composition.

In some embodiments, the amount of the ammonium salt is of about 0.5% to about 20% by weight, based on the total weight of the composition.

In a preferred embodiment, the amount of the ammonium salt is of about 0.5% to about 10% by weight, based on the total weight of the composition.

In more specific embodiment, the amount of the ammonium salt is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of ammonium sulfate is of about 0.5% to about 20% by weight, based on the total weight of the composition.

In a preferred embodiment, the amount of ammonium sulfate is of about 0.5% to about 10% by weight, based on the total weight of the composition.

In more specific embodiment, the amount of ammonium sulfate is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of the carrier is of about 0.05% to about 1%, based on the total weight of the composition.

In more specific embodiment, the amount of carrier is of about 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1% by weight, based on the total weight of the composition.

In more specific embodiment, the amount of silica is of about 0.05%, 0.1%, 0.15%, 0.2%, 0.25%, 0.3%, 0.35%, 0.4%, 0.45%, 0.5%, 0.55%, 0.6%,0.65%,0.7%, 0.75%,0.8%, 0.85%,0.9%, 0.95%, 1% by weight, based on the total weight of the composition.

In some embodiments, the composition of the invention is applied in an amount from about 0.1 L/ha to of about 1 L/ha. In a preferred embodiment, the composition of the invention is applied in an amount of about 0.8 L/ha.

In some embodiments, the composition is applied in an amount from about 100 g/ha of acephate to about 1000 g/ha of acephate. In a preferred embodiment, the composition is applied in an amount from about 400 g/ha of acephate to about 900 g/ha of acephate. In especially preferred embodiment, the solid agrochemical composition is applied in an amount of about 850 g/ha acephate.

In some embodiments, the composition is for controlling animal pests.

In some embodiments, the animal pest is selected from the family of Lepidoptera, Coleoptra, Diptera, and Hemiptera. In some embodiments, the animal pest is selected from aphids, white fly, thrips, fleahoppers, stink bugs and plant bugs.

The present invention also provides a method for reducing the odor of compositions containing acephate characterized by adding ammonium salt to solid compositions containing acephate and a carrier.

In some embodiments, the ammonium salt is selected from ammonium sulfate, ammonium acetate, ammonium carbonate, ammonium chloride and any combination thereof. In a preferred embodiment, the ammonium salt is ammonium sulfate.

In some embodiments, the carrier is selected from silica, layered silicate, phyllosilicate, china clay, bentonite, attapulgite, kaolin, diatomaceous earth, montmorillonite and any combination thereof.

In some embodiments, the amount of ammonium salt is equal to or above about 0.5% based on the total weight of the composition.

In some embodiments, the amount of the ammonium salt is of about 0.5% to about 20% by weight, based on the total weight of the composition.

In a preferred embodiment, the amount of the ammonium salt is of about 0.5% to about 10% by weight, based on the total weight of the composition.

In more specific embodiment, the amount of the ammonium salt is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of ammonium sulfate is of about 0.5% to about 20% by weight, based on the total weight of the composition.

In a preferred embodiment, the amount of ammonium sulfate is of about 0.5% to about 10% by weight, based on the total weight of the composition.

In more specific embodiment, the amount of ammonium sulfate is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of the carrier is of about 0.05% to about 1%, based on the total weight of the composition.

In more specific embodiment, the amount of carrier is of about 0.05%, 0.1%, 0.15%, 0.2%, 0.25%, 0.3%, 0.35%, 0.4%, 0.45%, 0.5%, 0.55%, 0.6%, 0.65%, 0.7%,0.75%,0.8%, 0.85%, 0.9%, 0.95%, 1% by weight, based on the total weight of the composition.

In some embodiments, the amount of silica is of about 0.05% to about 1%, based on the total weight of the composition.

In more specific embodiment, the amount of silica is of about 0.05%, 0.1%, 0.15%, 0.2%, 0.25%, 0.3%, 0.35%, 0.4%, 0.45%, 0.5%, 0.55%, 0.6%,0.65%,0.7%,0.75%,0.8%, 0.85%,0.9%, 0.95%, 1% by weight, based on the total weight of the composition.

In some embodiments, the amount of acephate is of about 10% to about 90% by weight, based on the total weight of the composition. In a preferred embodiment, the amount of acephate is of about 50% to about 90% by weight, based on the total weight of the composition. In a more preferred embodiment, the amount of acephate is of about 80% to about 90% by weight, based on the total weight of the composition.

In some embodiments, the compositions of the invention provides a method for controlling animal pests comprising applying an effective amount of the composition according to the invention to a locus where the animal pest is to be controlled and/or prevented so as to thereby control and/or prevent the animal pest.

In some embodiments, the locus is a crop field.

In some embodiment, the crop field on which the solid agrochemical compositions containing acephate may be used may be selected from but not limited to cereals, such as wheat, oats, barley, spelt, triticale, rye, maize, millet, rice, crops such as sugarcane, soybean, sunflower, rape, canola, tobacco, sugar beet, fodder beet; tuber crops such as potatoes, sweet potatoes etc., crops such as asparagus, hops etc.,; fruit plants such as apples, pears, stone-fruits such as for example peaches, nectarines, cherries, plums, apricots, citrus fruits such as oranges, grapefruit, limes, lemons, kumquats, mandarins, satsumas; nuts such as pistachios, almonds, walnuts, pecan nuts, tropical fruits such as mango, papaya, pineapple, dates, bananas etc., grapes, vegetables such as endives, lambs, lettuce, fennel, globe and loose-leaf salad, chard, spinach, chicory, cauliflower, broccoli, Chinese cabbage, kale (winter kale or curly kale), kohlrabi, Brussel sprouts, red cabbage, white cabbage and savoy, fruiting vegetables such as aubergines, cucumbers, paprika, marrow, tomatoes, courgettes, sweetcorn, root vegetables such as celeriac, turnip, carrots, swedes, radishes, horse radish, beetroot, salsify, celery, pulses such as peas, beans etc., bulb vegetables such as leeks, onions etc., oil crops such as mustard, poppy, olives, sunflowers, coconut, castor oil plants, cocoa beans, groundnuts; fibre crops such as cotton, jute, flex, hemp, crops such as tea, coffee, rubber, ornamentals including shrubs and flowering plants, vines, rangeland and pastures. In a preferred embodiment the crop filed is selected from maize, rice, soybean, sweetcorn, groundnuts and cotton. In a preferred embodiment, the crop field on which the solid agrochemical compositions containing acephate is selected from maize, rice, soybean, sweetcorn, groundnuts and cotton.

In some embodiments, the solid agrochemical compositions containing acephate effective against animal pests from the family Lepidoptera, Coleoptra, Diptera and Hemiptera. Examples of animal pests in which the composition is effective against are aphids, white fly, thrips, fleahoppers, stink bugs and plant bugs.

The present invention also provides the use of ammonium salts for reducing the odor of solid compositions containing acephate and a carrier.

In some embodiments, the ammonium salt is selected from ammonium sulfate, ammonium acetate, ammonium carbonate, ammonium chloride and any combination thereof. In a preferred embodiment, the ammonium salt is ammonium sulfate.

In some embodiments, the carrier is selected from silica, layered silicate, phyllosilicate, china clay, bentonite, attapulgite, kaolin, diatomaceous earth, montmorillonite and any combination thereof.

In some embodiments, the amount of ammonium salt is equal to or above about 0.5% based on the total weight of the composition.

In some embodiments, the amount of the ammonium salt is of about 0.5% to about 20% by weight, based on the total weight of the composition.

In a preferred embodiment, the amount of the ammonium salt is of about 0.5% to about 10% by weight, based on the total weight of the composition.

In more specific embodiment, the amount of the ammonium salt is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of ammonium sulfate is equal to or above about 0.5% based on the total weight of the composition.

In some embodiments, the amount of ammonium sulfate is of about 0.5% to about 20% by weight, based on the total weight of the composition.

In a preferred embodiment, the amount of ammonium sulfate is of about 0.5% to about 10% by weight, based on the total weight of the composition.

In more specific embodiment, the amount of ammonium sulfate is of about 0.5%, 0.8%, 1.1%, 1.4%, 1.7%, 2%, 2.3%, 2.6%, 2.9%, 3.2%, 3.5%, 3.8%, 4.1%, 4.4%, 4.7%, 5%, 5.3%, 5.6%, 5.9%, 6.2%, 6.5%, 6.8%, 7.1%, 7.4%, 7.7%, 8%, 8.3%, 8.6%, 8.9%, 9.2%. 9.5%, 9.8% or 10% by weight, based on the total weight of the composition.

In some embodiments, the amount of the carrier is of about 0.05% to about 1%, based on the total weight of the composition.

In more specific embodiment, the amount of carrier is of about 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1% by weight, based on the total weight of the composition.

In some embodiments, the amount of silica is of about 0.05% to about 1%, based on the total weight of the composition.

In more specific embodiment, the amount of silica is of about 0.05%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1% by weight, based on the total weight of the composition.

In some embodiments, the amount of acephate is of about 10% to about 90% by weight, based on the total weight of the composition. In a preferred embodiment, the amount of acephate is of about 50% to about 90% by weight, based on the total weight of the composition. In a more preferred embodiment, the amount of acephate is of about 80% to about 90% by weight, based on the total weight of the composition.

The invention is illustrated by the following examples without limiting it thereby.

### EXAMPLES

### Example 1-Formulation A

TABLE 1

| Component | % by weight |
|---|---|
| Acephate Tech | 85.0 |
| Bifenthrin Tech | 3.5 |
| Aerosil 200 | 0.5 |
| Atlox Metasperse 550S-PW-(AP) | 1.0 |
| (modified styrene acrylic polymer) | |
| Rhodapon LS 94RPB (sodium lauryl sulphate) | 3.5 |
| SAG 1572 (polydimethylsiloxane emulsion) | 0.2 |
| Soprophor 4D/384 (tristyrylphenol sulfate, | 1.0 |
| ammonium salt) | |
| Ammonium sulfate | 5.3 |

Formulations A, B and D-G were prepared in a similar manner by following procedure:

1. Premix of bifenthrin, Silica, modified styrene acrylic polymer and sodium laurylsuphate was blended and milled in jet mill.

2. The above premix is further blended with acephate followed by addition of hot mixture containing water, polydimethylsiloxane emulsion (SAG 1572) and ethoxylated tristyrylphenol sulphate ammonium (Soprophor 4D/384) heated at 55-60° C. and mixed well to form dough for extrusion.

3. The dough was then extruded by maintaining extrusion temperature of the granules below 55° C. The granules are further dried at 50°° C. in fluid bed dryer to attain moisture content less than 0.5%.

TABLE 2
Formulation -A

| | AMB, | AHS |
|---|---|---|
| Active Content (% by mass) | 14 days | 54 C., 14 days |
| Acephate | 86.19 | 86.89 |
| Bifenthrin | 3.75 | 3.83 |
| pH (1% aqueous solution) | 5.95 | 4.15 |
| Suspensibility, % w/w | | |
| Acephate | 98.49 | 99.00 |
| Bifenthrin | 91.00 | 90.00 |
| Wet sieve test (Passing | >99 | >99 |
| through 75 Micron), % w/w | | |
| Persistent foam | 28 ml | 25 ml |

Active content in the formulation was determined through HPLC analysis. The suspensibility of actives in the suspension was measured as below.

### Suspensibility of Actives:

Weigh about 1.7 g of the sample into a 250 ml beaker. Add about 50 g of 342 ppm hard water and make slurry by stirring well. Transfer the slurry in to 250 ml suspensibility cylinder and make up with 342 ppm water.

Mix the suspension by inverting the cylinder 30 times and allow it to stand for 30 min. Remove top 225 ml of the suspension by suction and analyze the remaining 25 ml of suspension in the cylinder for acephate and bifenthrin content by HPLC. Calculate the suspensibility as per CIPAC MT-184 method.

### Example 2-Formulation B

TABLE 3

| Component | % by weight |
|---|---|
| Acephate Tech | 88.66 |
| Bifenthrin Tech | 3.84 |
| PVPK30 | 0.2 |
| Ammonium sulfate | 3.0 |
| Sophrophor 4D384 | 0.2 |
| Metasperse 550 S | 2.0 |
| Rhodapon LZS 94RPB | 2.0 |
| SAG 1572 | 0.1 |

TABLE 4
Formulation -B

| | AMB, | AHS |
|---|---|---|
| Active Content (% by mass) | 14 days | 54 C., 14 days |
| Acephate | 86.57 | 83.67 |
| Bifenthrin | 3.50 | 3.52 |
| pH (1% aqueous solution) | — | — |
| Suspensibility % w/w | | |
| Acephate | 99.64 | 98.34 |
| Bifenthrin | 98.4 | 76.42 |

### Example 3-Formulation C

TABLE 5

| Component | % by weight |
|---|---|
| Acephate Tech | 85.0 |
| Bifenthrin Tech | 3.5 |
| Starch, Soluble (Certified ACS) | 2.0 |
| Supragil WP (alkyl naphthalene sulfonate) | 1.0 |
| Tersperse 2700 (copolymer of | 1.0 |
| methacrylate) | |
| SAG 1572 (polydimethylsiloxane | 0.2 |
| emulsion) | |
| Soprophor 3 D 33 ((A) 2,4,6-Tris(1- | 1.0 |
| phenylethyl)polyoxyethylenated | |
| phosphates, (B)Poly(oxy-1,2- | |
| ethanediyl),.alpha.-[tris(1- | |
| phenylethyl)phenyl]-.omega.-hydroxy-, | |
| (C)orthophosphoric acid) | |
| Ammonium sulfate | 6.0 |
| Precipitated Silica | 0.3 |

Formulation C was prepared by following procedure:
1. Bifenthrin and Silica were blended and milled in jet mill.
2. Acephate and all other ingredients were added to the above premix and blended well. Water was added to form dough, then extruded and the obtained granules were dried to attain moisture content less than 0.5%.

TABLE 6
Formulation -C

| | AMB, | AHS |
|---|---|---|
| Active Content (% by mass) | 14 days | 54 C., 14 days |
| Acephate | 88.38 | 87.93 |
| Bifenthrin | 3.52 | 3.39 |
| pH (1% aqueous solution) | 6.03 | 5.32 |
| Suspensibility % w/w | | |
| Acephate | 77.02 | 82.42 |
| Bifenthrin | 54.86 | 39.01 |
| Wet sieve test (Passing | >99 | >99 |
| through 75 Micron), % w/w | | |
| Persistent foam | 10 ml | 10 ml |

### Example 4-Efficacy for Control of Stink Bugs Adults (Euschistus heros)

TABLE 7

| | | | % Control (10 days after |
|---|---|---|---|
| # | Treatment | Application rate g AI/Ha | application) |
| 1 | Formulation | 850 acephate/35 | 87 |
| | A | bifenthrin | |
| 2 | Formulation | 850 acephate/35 | 78 |
| | C | bifenthrin | |
| 3 | Tank mix | 850 acephate/35 | 71 |
| | (acephate and | bifenthrin | |
| | bifenthrin) | | |

Six field trails were conducted each trail was designed as a randomized block trail containing 13 treatments and four replicates (total 52 plots per trail). Each plot size in every replicate was 36m2, all the plants in each replicate were treated with each of the tested formulations.

Formulations A, C and the tank mix were applied via foliar application on soybean plants, a backpack sprayer pressurized with CO2 was used for the formulation application, with a boom equipped with six-fan-type nozzles (110,015), spaced at 50 cm, with a constant pressure of 40 PSI and providing a volume of 150 L.ha-1.

The treatments were applied during the growing season of the stink bugs (Avg. Temperature of 24° C. Relative Humidity of 50-70%), following foliar pest infestation level of average of ˜2-5 adults sting bugs per plant.

10 days after the application (DAA), the pest evaluation was conducted on the adult stage by batting cloth (minimum of two beats per 1m2) and the number of alive adults was documented.

The values in Table 7 represents the efficacy of each treatment versus the untreated control.

### Conclusions

Formulations A, C and tank mix of acephate and bifenthrin were evaluated for the control of adult stink bugs. The results in Table 7 clearly show that formulation A which has better dispersibility parameter are more potent than formulation C and the tank mix.

### Example 4-Odor Testing

TABLE 8

| | Formu- | Formu- | Formu- | Formu- |
|---|---|---|---|---|
| | lation | lation | lation | lation |
| | D (% by | E (% by | F (% by | G (% by |
| Component | weight) | weight) | weight) | weight) |
| Acephate | 89.38 | 89.38 | 89.38 | 89.38 |
| Bifenthrin | 3.74 | 3.74 | 3.74 | 3.74 |
| Metasperse 550 S | 1.00 | 1.00 | 1.00 | 1.00 |
| Rhodapon LZS | 3.50 | 3.50 | 3.50 | — |
| 94RPB | | | | |
| SAG 1572 | 0.20 | 0.20 | 0.20 | 0.20 |
| Aerosil 200 | 0.50 | 0.50 | 0.50 | 0.50 |
| Ammonium Sulfate | 0.68 | — | 1.68 | 4.18 |
| Soprophor 4D384 | 1.00 | 1.00 | — | 1.00 |
| Odor rating | 5 | 7 | 4 | 4 |

### Assay Procedure:

The odor analysis of the samples was conducted by two individuals. The sample pouch containing ˜100 g was kept closed overnight before it was examined for odor rating. The pouch was opened and brought about 3-4 inches near the face and was inhaled twice for 5 s. The smell emanating from the pouch was sensed and rated on 1-10 scale, with 1 as no or low/minimal odor and 10 as extreme unmanageable strong odor.

### Conclusions

The odor rating of formulations D-G indicates that the presence of ammonium sulfate decreases the intensity of the smell originate from acephate. Formulation E without ammonium sulfate possesses a strong odor while formulations D, F and G with different amounts of ammonium sulfate show substantially odor reduction.

1.-58. (canceled)

59. A solid agrochemical composition comprising a) at least one insecticide which is substantially insoluble in water; b) ammonium salt; c) at least one anionic surfactant containing sulfate or sulfonate group and d) a carrier.

60. The solid agrochemical composition according to claim 59, wherein the at least one anionic surfactant containing sulfate or sulfonate functional group is selected from a) optionally alkylated naphthalene sulfonate condensate; b) lignosulphonates and/or compounds having the formula (I):
MO—SO₂-(CqH2q)p-[D]z-(CmH2mO)x-(CnH2nO)y-R
wherein R is linear or branched, saturated or unsaturated alkyl radical having from 7 to 20 carbon atoms; or R is a saturated or unsaturated carbonyl radical having from 5 to 20 carbon atoms; or R is aryl, alkyl aryl or aryloxy radical which is optionally mono-to trisubstituted by alkyl or styryl group; or any combination thereof, D represents oxygen or methylated Nitrogen, M represents an ammonium or alkali metal cation, z is an integer from 0 to 1, p is an integer from 0 to 1, m is an integer equal to 2, n is an integer equal to 3, q is an integer of from 2 to 3, x is an integer of from 0 to 50 and y is an integer of from 0 to 50.

61. The solid agrochemical composition according to claim 59, wherein: (a) the amount of the anionic surfactant containing sulfate or sulfonate functional group is equal to or above about 2% based on the total weight of the composition; (b) the ammonium salt is selected from ammonium sulfate, ammonium acetate, ammonium carbonate, ammonium chloride and any combination thereof; preferably the ammonium salt is ammonium sulfate; and/or (c) the ratio between the anionic surfactant containing sulfate or sulfonate functional group and the ammonium salt is of about 1:0.5 to of about 1:5.

62. The solid agrochemical composition according to claim 59, wherein the carrier is selected from silica, layered silicate, phyllosilicate, china clay, bentonite, attapulgite, kaolin, diatomaceous earth, montmorillonite and any combination thereof.

63. The solid agrochemical composition according to claim 59, wherein the at least one insecticide which is substantially insoluble in water is selected from the group of fipronil, pyrethroide, chlorantraniliprole, chlorfenapyr, chlorpyrifos, cyantraniliprole, fenoxycarb, flufenoxuron, hydramethylnon, imidacloprid, indoxacarb, metaflumizone, allethrin, alpha-cypermethrin, beta-cyfluthrin, bifenthrin, bioallethrin, cyfluthrin, cyhalothrin, cypermethrin, deltamethrin, etofenprox, fenoxycarb, flufenoxuron, permethrin, pyriproxifen, tebufenozide, tralomethrin and metaflumizone and any combination thereof; preferably the at least one insecticide which is substantially insoluble in water is bifenthrin.

64. The solid agrochemical composition according claim 59, wherein the amount of the at least one insecticide which is substantially insoluble in water is of about 0.1% to about 90% by weight, based on the total weight of the composition; preferably the amount of the at least one insecticide which is substantially insoluble in water is of about 0.5% to about 50% by weight, based on the total weight of the composition; more preferably the amount of the at least one insecticide which is substantially insoluble in water is of about 1% to about 10% by weight, based on the total weight of the composition.

65. The solid agrochemical composition according to claim 59, wherein further comprising phosphoramidothioate insecticide.

66. The solid agrochemical composition according to claim 65, wherein the phosphoramidothioate insecticide is selected from acephate, chloramine phosphorus, isofenphos-methyl, methamidophos and any combination thereof; preferably the phosphoramidothioate insecticide is acephate.

67. The solid agrochemical composition according to claim 65, wherein the amount of the phosphoramidothioate insecticide is of about 10% to about 90% by weight, based on the total weight of the composition; preferably, the amount of the phosphoramidothioate insecticide is of about 50% to about 90% by weight, based on the total weight of the composition.

68. A method for controlling animal pests comprising applying an effective amount of the composition of claim 59 to a locus where the animal pest is to be controlled and/or prevented so as to thereby control and/or prevent the animal pest.

69. The method of claim 68, wherein: (a) the locus is a crop field; preferably wherein the crop is selected from maize, rice, soybean, sweetcorn, groundnuts and cotton; (b) the animal pest is selected from aphids, white fly, thrips, fleahoppers, stink bugs and plant bugs; (c) the composition is applied in an amount from about 0.1 L/ha to of about 1 L/ha; (d) the composition is applied in an amount from about 10 g/ha of the at least one insecticide which is substantially insoluble in water to about 50 g/ha of the at least one insecticide which is substantially insoluble in water; and/or (e) the composition is applied in an amount from about 100 g/ha of the phosphoramidothioate insecticide to about 1000 g/ha of the phosphoramidothioate insecticide.

70. A solid agrochemical composition comprising acephate, ammonium salt and a carrier.

71. The solid agrochemical composition according to claim 70, wherein the ammonium salt is selected from ammonium sulfate, ammonium acetate, ammonium carbonate, ammonium chloride and any combination thereof; preferably, the ammonium salt is ammonium sulfate.

72. The solid agrochemical composition according to claim 70, wherein the carrier is selected from silica, layered silicate, phyllosilicate, china clay, bentonite, attapulgite, kaolin, diatomaceous earth, montmorillonite and any combination thereof.

73. The solid agrochemical composition according to claim 70, wherein the amount of acephate is from about 10% to about 90% by weight, based on the total weight of the composition; preferably, the amount of acephate is of about 50% to about 90% by weight, based on the total weight of the composition.

74. The solid agrochemical composition according to claim 70, wherein the amount of ammonium salt is equal to or above about 0.5% based on the total weight of the composition.

75. A method for reducing the odor of compositions containing acephate characterized by adding ammonium salt to solid compositions containing acephate and a carrier.

76. The method according to claim 75, wherein: (a) the ammonium salt is selected from ammonium sulfate, ammonium acetate, ammonium carbonate, ammonium chloride and any combination thereof; preferably, the ammonium salt is ammonium sulfate; (b) the carrier is selected from silica, layered silicate, phyllosilicate, china clay, bentonite, attapulgite, kaolin, diatomaceous earth, montmorillonite and any combination thereof; (c) the amount of ammonium salt is equal to or above about 0.5% based on the total weight of the composition; and/or (d) the amount of acephate is of about 10% to about 90% by weight, based on the total weight of the composition; preferably, the amount of acephate is of about 50% to about 90% by weight, based on the total weight of the composition.

77. A method for controlling animal pests comprising applying an effective amount of the composition of claim 70 to a locus where the animal pest is to be controlled and/or prevented so as to thereby control and/or prevent the animal pest.

78. The method according to claim 77, wherein: (a) the locus is a crop field; preferably wherein the crop is selected from maize, rice, soybean, sweetcorn, groundnuts and cotton; (b) the animal pest is selected from aphids, white fly, thrips, fleahoppers, stink bugs and plant bugs; (c) the composition is applied in an amount from about 0.1 L/ha to of about 1 L/ha; the composition is applied in an amount from about 100 g/ha of acephate to about 1000 g/ha of acephate.
